(19) United States
(12) Patent Application Publication
(10) Pub. No.: US 2024/0060912 A1
(43) Pub. Date: Feb. 22, 2024

(54) ENERGY DISPERSIVE X-RAY SPECTROSCOPY SENSING UNIT BACKGROUND

(71) Applicant: APPLIED MATERIALS ISRAEL LTD., Rehovot (IL)

(72) Inventors: Martin Chauvin, Rehovot (IL); Eitam Vinegrad, Rehovot (IL); Itay Asulin, Rehovot (IL)

(73) Assignee: APPLIED MATERIALS ISRAEL LTD., Rehovot (IL)

(21) Appl. No.: 17/891,473

(22) Filed: Aug. 19, 2022

(51) Int. Cl. G01N 23/20091; G01N 23/2252

(52) U.S. Cl. CPC G01N 23/20091; G01N 23/2252; G01N 2223/079

(57) ABSTRACT

An EDX sensing unit that includes an x-ray sensor including one or more sensing regions, and a protective unit that is configured to introduce a change in one or more properties of electrons emitted from the sample, thereby preventing the electrons emitted from the sample from reaching the one or more sensing regions; wherein the electrons are emitted from the sample due to an illuminating of the sample by a primary electron beam. The x-ray sensor is configured to (i) receive, by the one or more sensing regions, x-ray photons emitted from the sample due to the illuminating of the sample, and (ii) generate detection signals indicative of the x-ray photons.

### BACKGROUND

### Background of the Invention

Energy dispersive x-ray spectroscopy (EDX) is an analytic technique used for the chemical characterization or for the elemental analysis of a sample.

A high output count rate EDX requires to maximize the collection solid angle of the x-ray detector.

A sample is illuminated with a primary electron beam. The illumination causes the sample to emit x-ray photons but also to emit electrons. The electrons may alter the reading and possibly damage the x-ray sensor.

There is a growing need to provide an EDX sensing unit that may protects the x-ray sensor from impinging electrons while maintaining a high solid angle and causing minimal distortion to the photon energetic spectrum.

### BRIEF SUMMARY OF THE INVENTION

There may be provided an energy-dispersive x-ray spectroscopy (EDX) sensing unit, that may include (i) an x-ray sensor comprising one or more sensing regions; and (ii) a protective unit that is configured to introduce a change in one or more properties of electrons emitted from a sample, thereby preventing the electrons emitted from the sample from reaching the one or more sensing regions; wherein the electrons are emitted from the sample due to an illuminating of the sample by a primary electron beam. The x-ray sensor is configured to (i) receive, by the one or more sensing regions, x-ray photons emitted from the sample due to the illuminating of the sample, and (ii) generate detection signals indicative of the x-ray photons.

There may be provided a method for EDX sensing, the method may include (i) illuminating a sample with a primary electron beam, wherein the illuminating causes the sample to emit electrons and x-ray photons; (ii) introducing, by a protective unit, a change in one or more properties of the electrons, thereby preventing the electrons from reaching one or more sensing regions of a x-ray sensor; (iii) receiving by the one or more sensing regions, the x-ray photons; and (iv) generating, by the x-ray sensor, detection signals indicative of the x-ray photons received by the one or more sensing regions.

### BRIEF DESCRIPTION OF THE DRAWINGS

The subject matter regarded as the embodiments of the disclosure is particularly pointed out and distinctly claimed in the concluding portion of the specification. The embodiments of the disclosure, however, both as to organization and method of operation, together with objects, features, and advantages thereof, may best be understood by reference to the following detailed description when read with the accompanying drawings in which:

FIG. 1 is an example of an EDX sensing unit;

FIG. 2 is an example of an EDX sensing unit;

FIG. 3 is an example of an EDX sensing unit;

FIG. 4 is an example of an EDX sensing unit; and

FIG. 5 is an example of a method.

### DETAILED DESCRIPTION OF THE INVENTION

In the following detailed description, numerous specific details are set forth in order to provide a thorough understanding of the embodiments of the disclosure.

However, it will be understood by those skilled in the art that the present embodiments of the disclosure may be practiced without these specific details. In other instances, well-known methods, procedures, and components have not been described in detail so as not to obscure the present embodiments of the disclosure.

The subject matter regarded as the embodiments of the disclosure is particularly pointed out and distinctly claimed in the concluding portion of the specification. The embodiments of the disclosure, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the disclosure may for the most part, be implemented using electronic components and circuits known to those skilled in the art, details will not be explained in any greater extent than that considered necessary as illustrated above, for the understanding and appreciation of the underlying concepts of the present embodiments of the disclosure and in order not to obfuscate or distract from the teachings of the present embodiments of the disclosure.

The term “and/or” means additionally or alternatively.

In contrary to detectors that have either a thick window that alters the photon spectrum and hinder collection, or detectors that are placed far away from the sample and hence with inherently low collection, even with the thinnest windows—the suggested solution—by partially or entirely removing the protective window rom detector with large solid angle—enables simultaneously high throughput and high fidelity in photon spectrum retrieval.

There is provided an energy-dispersive x-ray spectroscopy (EDX) sensing unit that includes an x-ray sensor that is protected from electrons, has a large solid angle, and does not substantially distort the energy spectrum of photons reaching the x-ray sensor.

The large solid angle requires the x-ray sensor to be close to the sample and around the primary beam and thus may require preventing energetic electrons leaving the wafer or the sample under test from hitting the x-ray sensor.

The x-ray sensor has one or more sensing regions. The EDX sensing unit may include a protective unit that is configured to introduce a change in one or more properties of electrons emitted from the sample, thereby preventing the electrons emitted from the sample from reaching the one or more sensing regions. The one or more properties may be speed or trajectory.

The suggested EDX sensing unit improves photons detection, for example improves the x-ray photon detection over an entire energy range (up to an primary electron beam energy), with a significant benefit at energies below 1 keV.

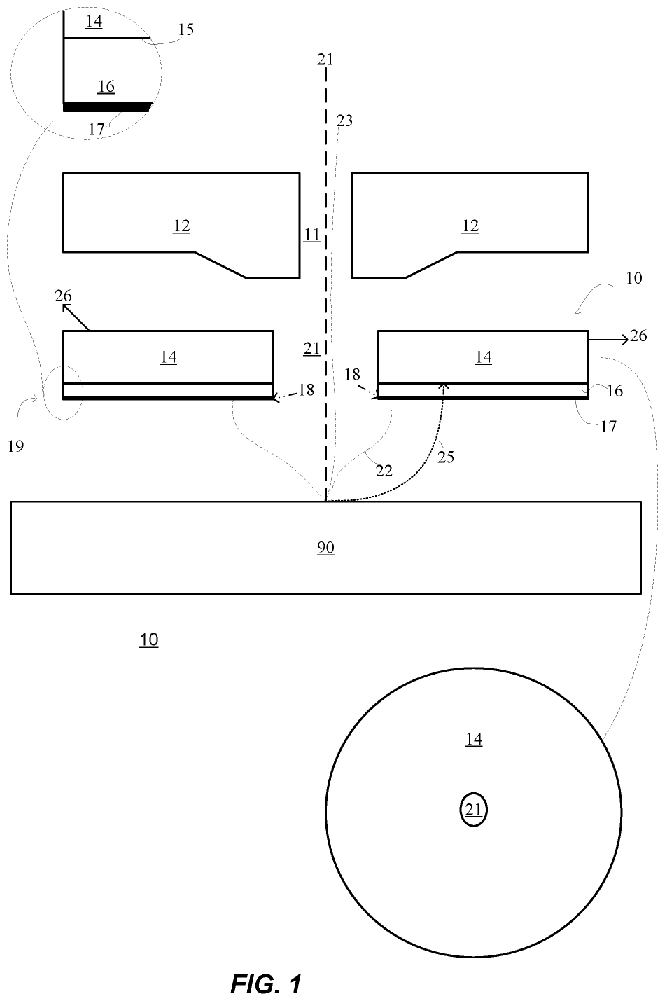

FIGS. 1-4 illustrate examples of a sample, EDX sensing unit 10, and a lower tip 12 of a column of an EDX system such as a scanning electron microscope configured to perform EDX measurements. FIGS. 1-4 may be in scale or may be out of scale.

FIG. 1 illustrates sample 90, lower tip 12 and EDX sensing unit 10.

The EDX sensing unit 10 includes x-ray sensor 14 and protective unit 19.

The x-ray sensor 14 includes sensing region 15 which is the lower surface of the x-ray sensor 14.

The protective unit 19 includes window 16 and an electrode 17 that is biased by bias voltage 18. The electrode 17 is located between the sample and the window 16, the window is located between the electrode 17 and the x-ray sensor 14. It should be noted that the electrode 17 may be inside window 16 or above window 16. The electrode and the window may be integrated—for example provide a single unit.

The x-ray sensor 14 may be grounded.

The thickness of the window 16 is a fraction of a thickness of a window that should be required at an absence of the electrode 17.

The fraction may not exceed ½, ⅓, ¼, and the like of the window without the electrode 17. For example, the window may have a thickness of some hundreds of nanometers (for example five hundred nanometers) instead of at least one micron. It should be noted that a biased window may have a thickness that may exceed one micron.

The electrode may be transparent to x-ray photons.

The overall distortion of the photon energy spectrum introduced (by protective unit 19) to x-ray photons that reach the x-ray sensor is a fraction of the overall distortion introduced when using a much thicker window without the electrode 17.

The x-ray sensor 14 is configured to (i) receive, by the one or more sensing regions (for example sensing region 15), x-ray photons 25 emitted from the sample due to the illuminating of the sample, and (ii) generate detection signals 16 indicative of the x-ray photons. The detection signals 26 may be sent to a buffer and/or a processor (not shown) for performing EDX analysis.

FIG. 1 also illustrates primary electron beam 21, electrons 22 emitted from the sample and are suppressed by the protective unit 19, and electrons that are emitted from the sample and may propagate through a protective unit opening 21 and through an x-ray sensor opening 11 to enter lower tip 12 and the column (not shown). The electrons 23 emitted from the wafer may be detected by an electron detector (not shown). The same applied to the backscattered electrons.

FIG. 1 also shows that the x-ray sensor 14 has an annular shape. The x-ray sensor may be segmented and may have shaped other than annular.

It should be noted that the primary electron beam 21 also propagated through the protective unit opening 21 and through the x-ray sensor opening 11.

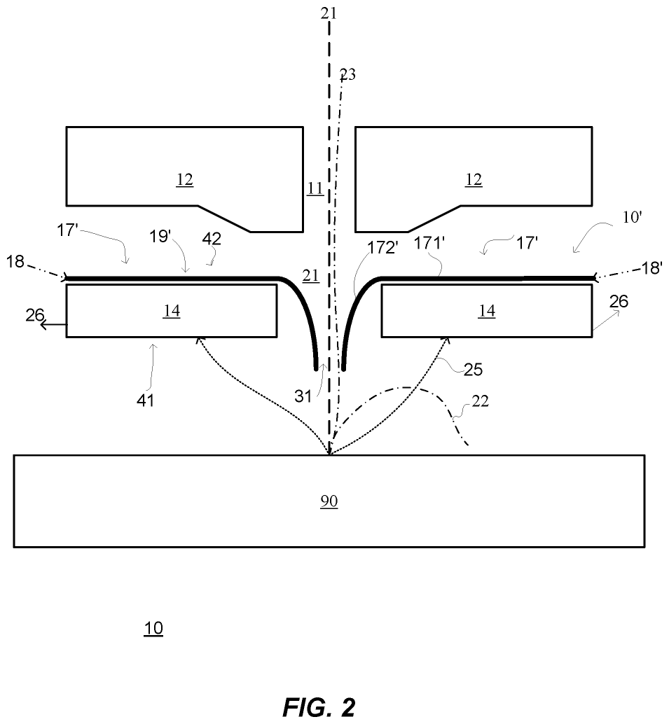

FIGS. 2-4 illustrate examples of sample 90, lower tip 12 and EDX sensing unit 10.

The EDX sensing unit 10 of FIGS. 2-4 includes x-ray sensor 14 and protective unit 19′.

The x-ray sensor 14 includes sensing region 15 which is the lower surface of the x-ray sensor 14.

The protective unit 19′ is a windowless protective unit as there is no window between the sample and the x-ray sensor.

Protective unit 19′ include a biased electrode 17′ that is biased by bias voltage 18′ and introduces an electrostatic field. A voltage difference between the wafer and the x-rays sensor 14 prevents electrons 22 from reaching the x-ray sensor. Electrons 23 propagate through an electrode opening 31, a protective unit opening 21 and an x-ray sensor opening 11 into tip 12.

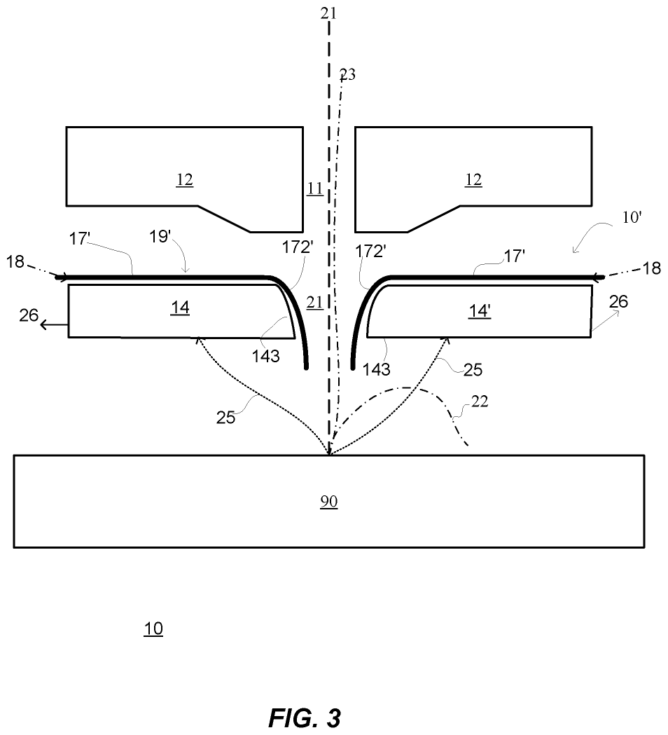

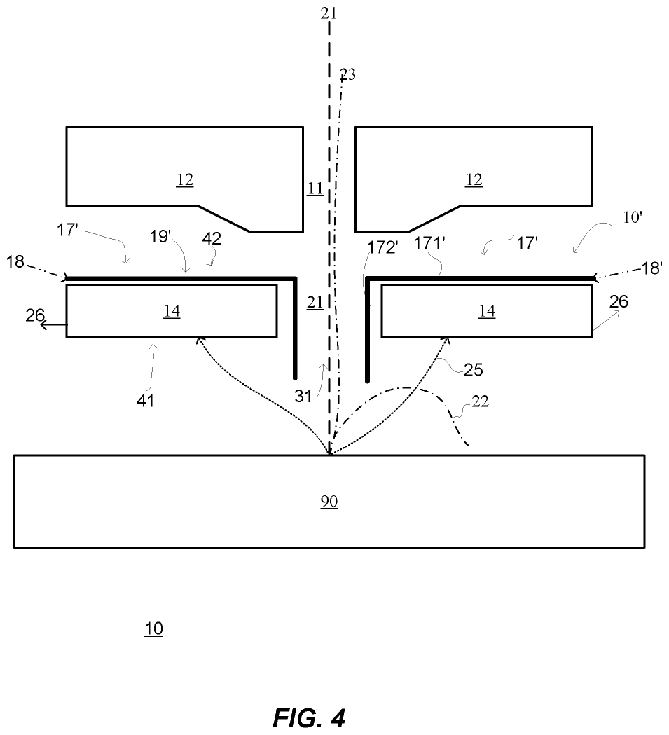

In FIGS. 2 and 3 the bias electrode 17′ has an upper portion 171′ located above the x-ray detector 14, and a lower portion 172′ that passes through the x-ray sensor opening 21 and extends outside the x-ray detector, as the lower end of the lower portion is closer to the sample than the lower surface of the x-ray detector. The bias electrode may have any shape and may have any orientation, for example, the lower portion of the electrode may be vertical (see, for example, FIG. 4), or may be linear or curved (see, for example, FIGS. 2 and 3).

In FIGS. 2 and 3 the protective unit 19′ has a sample side 41 that faces the sample and a column side 42 that faces the lower tip 12. The lower tip is an example of a lower part of an objective lens.

The cross section of the x-ray sensor may have any shape—for example may have a rectangular shape (see, for example FIGS. 1, 2 and 4), may include a curved plane (see, for example, FIG. 3). The cross section of the lower portion of the bias electrode may be the same or similar to a shape of a facet or side of the x-ray sensor that is closest to the lower portion of the bias electrode (see, for example, FIGS. 3 and 4)— or may be of a significantly different shape (see, for example, FIG. 2).

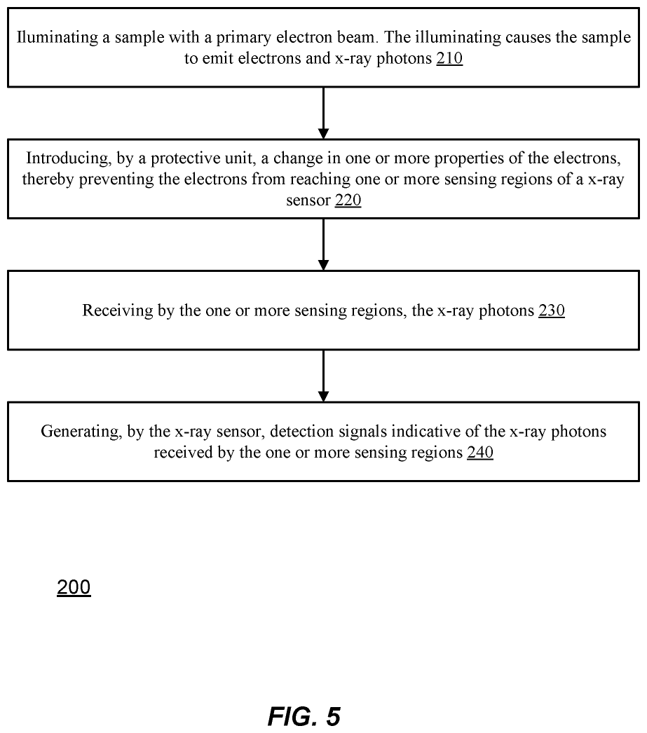

FIG. 5 is an example of method 200 for EDX sensing.

Method 200 may be executed by any of the EDX sensing units illustrated in any one of FIGS. 1-4.

Method 200 may include step 210 of illuminating a sample with a primary electron beam. The illuminating causes the sample to emit electrons and x-ray photons.

Step 210 may be followed by step 220 of introducing, by a protective unit, a change in one or more properties of the electrons, thereby preventing the electrons from reaching one or more sensing regions of a x-ray sensor. The x-ray sensor may have a solid angle that exceeds 1 steradian. Yet for another example, the x-ray sensor may have a solid angle that does not exceeds 1 steradian.

Step 220 may be followed by step 230 of receiving by the one or more sensing regions, the x-ray photons.

Step 220 may be followed by step 240 of generating, by the x-ray sensor, detection signals indicative of the x-ray photons received by the one or more sensing regions.

The one or more properties may include speed (see for example FIG. 1) and trajectory (see for example, FIGS. 2 and 3).

Step 220 may include introducing the change by one or more biased electrodes, without using a window that faces a sample side of the EDX sensing unit.

Step 220 may include introducing the change by a combination of one or more biased electrodes, and a thin window that faces a sample side of the EDX sensing unit.

In the foregoing specification, the embodiments of the disclosure has been described with reference to specific examples of embodiments of the disclosure. It will, however, be evident that various modifications and changes may be made therein without departing from the broader spirit and scope of the embodiments of the disclosure as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the disclosure described herein are, for example, capable of operation in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to be a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to embodiments of the disclosure s containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the embodiments of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the embodiments of the disclosure.

What is claimed is:

1. An energy-dispersive x-ray spectroscopy (EDX) sensing unit, comprising:
an x-ray sensor comprising one or more sensing regions; and
a protective unit that is configured to introduce a change in one or more properties of electrons emitted from a sample, thereby preventing the electrons emitted from the sample from reaching the one or more sensing regions;
wherein the electrons are emitted from the sample due to an illuminating of the sample by a primary electron beam, and wherein the x-ray sensor is configured to (i) receive, by the one or more sensing regions, x-ray photons emitted from the sample due to the illuminating of the sample, and (ii) generate detection signals indicative of the x-ray photons.

2. The EDX sensing unit according to claim 1 wherein the one or more properties comprise speed and trajectory.

3. The EDX sensing unit according to claim 1 wherein the protective unit comprises at least one biased electrode that is configured to introduce the change.

4. The EDX sensing unit according to claim 1 wherein the x-ray sensor has a solid angle that exceeds 1 steradian.

5. The EDX sensing unit according to claim 1 wherein the x-ray sensor comprises an x-ray sensor opening and the protective unit comprises a protective unit opening.

6. The EDX sensing unit according to claim 1 wherein at least one portion of the protective unit extends outside the x-ray sensor.

7. The EDX sensing unit according to claim 1 wherein the EDX sensing unit is a windowless EDX sensing unit.

8. The EDX sensing unit according to claim 1 wherein the EDX sensing unit is without a window that faces a sample side of the EDX sensing unit, and wherein at least one portion of the at one biased electrode passes through an entirety of an x-ray sensor opening and extends outside the x-ray sensor.

9. The EDX sensing unit according to claim 1 wherein the EDX sensing unit is a windowless EDX sensing unit, and wherein at least one portion of the at one biased electrode is positioned within an x-ray sensor opening.

10. The EDX sensing unit according to claim 9 wherein at least one portion of the at one biased electrode passes through an entirety of the x-ray sensor opening.

11. The EDX sensing unit according to claim 1 wherein the EDX sensing unit comprises a window.

12. The EDX sensing unit according to claim 11 wherein a thickness of the window does not exceed 1000 nanometers.

13. A method for energy-dispersive x-ray spectroscopy EDX sensing, the method comprising:
illuminating a sample with a primary electron beam, wherein the illuminating causes the sample to emit electrons and x-ray photons;
introducing, by a protective unit, a change in one or more properties of the emitted electrons, thereby preventing the emitted electrons from reaching one or more sensing regions of a x-ray sensor;
receiving, by the one or more sensing regions, the x-ray photons; and
generating, by the x-ray sensor, detection signals indicative of the x-ray photons received by the one or more sensing regions.

14. The method according to claim 13 wherein the one or more properties comprise speed and trajectory.

15. The method according to claim 13 wherein the EDX sensing unit is without a window that faces a sample side of the EDX sensing unit.

16. The method according to claim 13 wherein the EDX sensing unit comprises a window having a thickness that does not exceed 1000 nanometers, the window faces a sample side of the EDX sensing unit.

17. The method according to claim 13 comprising introducing the change using at least one biased electrode of the protective unit.

18. The method according to claim 13 wherein the x-ray sensor has a solid angle that exceeds 1 steradian.
